(19) United States
(12) Patent Application Publication
(10) Pub. No.: US 2011/0167345 A1
(43) Pub. Date: Jul. 7, 2011

(54) METHOD AND APPARATUS FOR SELECTIVE MEDIA DOWNLOAD AND PLAYBACK

(76) Inventors: Jeremy Jones, San Jose, CA (US); Meriko Borogove, San Francisco, CA (US); Patrick Coffman, San Francisco, CA (US)

(21) Appl. No.: 12/891,560

(22) Filed: Sep. 27, 2010

Related U.S. Application Data
(60) Provisional application No. 61/292,839, filed on Jan. 6, 2010.
(60) Provisional application No. 61/298,527, filed on Jan. 26, 2010.

(51) Int. Cl. G06F 15/16; G06F 3/01

(52) U.S. Cl. 715/716; 709/217

(57) ABSTRACT

A computing device is capable of playing embedded media inline in a network application. A playable validation procedure is performed for the embedded media objects, which have a media source remote from the computing device, to determine whether those embedded media objects are playable on the computing device. The playable validation procedure continues for each embedded media object regardless if one of those objects is selected and is playing inline in the network application. A preview frame loading procedure is also performed on the embedded media objects when it would not substantially affect the playback of a currently playing embedded media object. The preview frame loading procedure loads one or more frames to act as preview frames for the embedded media object.

### CROSS-REFERENCE TO RELATED APPLICATIONS

This application claims the benefit of U.S. Provisional Application No. 61/298,527, filed Jan. 26, 2010, and U.S. Provisional Application No. 61/292,839, filed Jan. 6, 2010, which are both hereby incorporated by reference.

### BACKGROUND

1. Field

Embodiments of the invention relate to the field of media playback; and more specifically, to selective media download and playback.

2. Background

Computing devices (e.g., workstations, laptops, palmtops, mobile phones, smartphones, multimedia phones, tablets, portable media players, GPS units, gaming systems, etc.) commonly are capable of playing media files (e.g., video and/or audio files) downloaded and streamed from a network (e.g., the Internet). For example, computing devices may include a network application (e.g., a web browser) which allows users to download and/or stream media files embedded on a web page.

Media files are created in a variety of formats. Some media files may not be playable by a particular computing device because of limitations of that device (e.g., that device may not have the appropriate media codec installed, etc.).

Some computing devices have a limited viewing area (e.g., certain mobile phones, smartphones, etc.) in which to view the playback of a media file. Because of this limitation, when an embedded media file on a web page is selected for playback, it is common for the computing device to force the media file to be played in full-screen mode rather than inline mode.

### SUMMARY

A method and apparatus for selective media download and playback is described. In one embodiment, a computing device (e.g., workstation, laptop, palmtop, mobile phone, smartphone, multimedia phone, tablet, portable media player, GPS unit, gaming system, etc.) is capable of playing media embedded in a network application page (e.g., a page displayed by a web browser, etc.) in inline mode. The computing device performs a playable validation procedure for the embedded media objects, which have a media source remote from the computing device, to determine whether those embedded media objects have media files that are playable on the computing device. A playable indicator is displayed for those embedded media objects that are playable.

In one embodiment, the playable validation procedure performed on the embedded media items is not substantially interrupted when one of those embedded media items is selected and is playing in inline mode. As used herein, inline mode refers to the capability of playing a media file corresponding with an embedded media object within the area defined for that embedded media object and without opening a separate application (e.g., a separate media player). For example, in a web browser application, the area for the embedded media object is typically defined through HTML code of a web page and the media file plays within the embedded media object. Thus the playable validation procedure continues for each of the embedded media objects regardless of whether one or more of the embedded media objects is playing media in inline mode.

In one embodiment, a preview loading procedure is performed for one or more of the embedded media objects when it would not substantially affect the playback of a media file playing in inline mode. Periods when performance of the preview loading procedure would not substantially affect the playback of a currently playing embedded media file are referred to herein as preview loading procedure opportune moments (“opportune moments”). The preview loading procedure will load and display one or more frames of the embedded media file to act as a preview for that embedded media file (e.g., a poster frame associated with the embedded media object). In one embodiment, if the embedded media object is associated with one or more preview frames (e.g., a poster frame has been defined and associated with the embedded media object), those preview frames are downloaded and displayed as the preview frames. If the embedded media object is not associated with a preview frame (e.g., a poster frame has not been defined for that embedded media object), one or more preview frames are dynamically generated based on a portion of the embedded media file. In one embodiment, the preview loading procedure prioritizes those embedded media objects that are currently viewable on the display as compared to those embedded media objects that are not currently viewable on the display.

### BRIEF DESCRIPTION OF THE DRAWINGS

The invention may best be understood by referring to the following description and accompanying drawings that are used to illustrate embodiments of the invention. In the drawings:

FIG. 1 illustrates an exemplary computer network according to one embodiment;

FIG. 2 illustrates a network application page displayed on a computing device with multiple embedded media objects according to one embodiment;

FIG. 3 is a flow chart illustrating exemplary operations for selective media download and playback according to one embodiment;

FIG. 4 is a block diagram illustrating exemplary selective media download and playback processing components according to one embodiment;

FIG. 5 is a flow chart illustrating exemplary operations for a preview loading procedure according to one embodiment;

FIG. 6 is a flow chart illustrating exemplary operations for dynamically generating one or more preview frames for an embedded media object according to one embodiment;

FIG. 7 is a flow chart illustrating exemplary operations for an alternative embodiment for dynamically generating one or more preview frames for an embedded media object;

FIGS. 8A-8B are flow charts illustrating exemplary operations for determining whether an embedded media object is playable on a computing device according to one embodiment;

FIG. 9 illustrates an example of an atom in an MPEG4 media file according to one embodiment;

FIG. 10 is a block diagram illustrating an exemplary computing device according to one embodiment; and

FIG. 11 is a block diagram illustrating an exemplary computing device according to an alternative embodiment.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

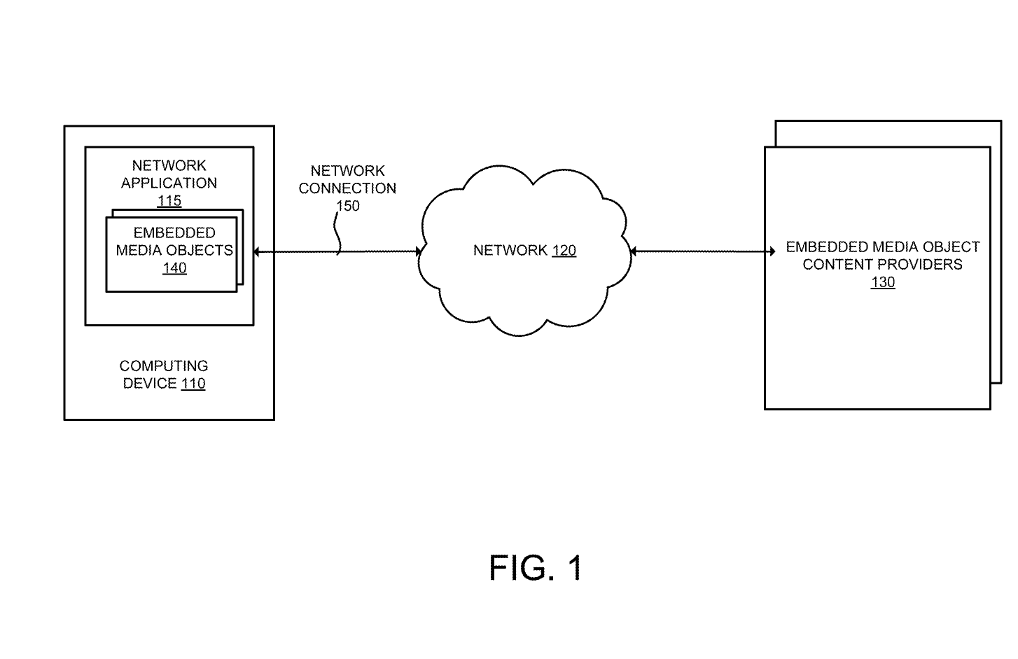

FIG. 1 illustrates an exemplary computer network according to one embodiment. As illustrated in FIG. 1, the computing device 110 (e.g., a workstation, a laptop, a palmtop, a mobile phone, a smartphone, a multimedia phone, a tablet, a portable media player, a GPS unit, a gaming system, etc.) includes the network application 115 (e.g., a web browser, Internet-enabled application, or other application which retrieves and displays content over a network). The network application 115 retrieves and displays the embedded media objects 140 through the network 120 (e.g., Internet) from the embedded media object content providers 130 over the network connection 150 (e.g., a wired connection, a wireless connection (e.g., Wi-Fi, cellular, satellite, etc.)). Each embedded media object content provider 130 may include a set of one or more servers which store and supply the files (media item(s)) for the embedded media objects. Thus the embedded media objects 140 have a media source remote to the computing device 110. It should be understood that the network application 115 is capable of retrieving and displaying content from content providers other than, or in addition to, the embedded media object content providers 130. The computing device 110 is capable of playing media files (at least those determined to be playable) inline through the embedded media objects 140 (which will be described in greater detail later herein).

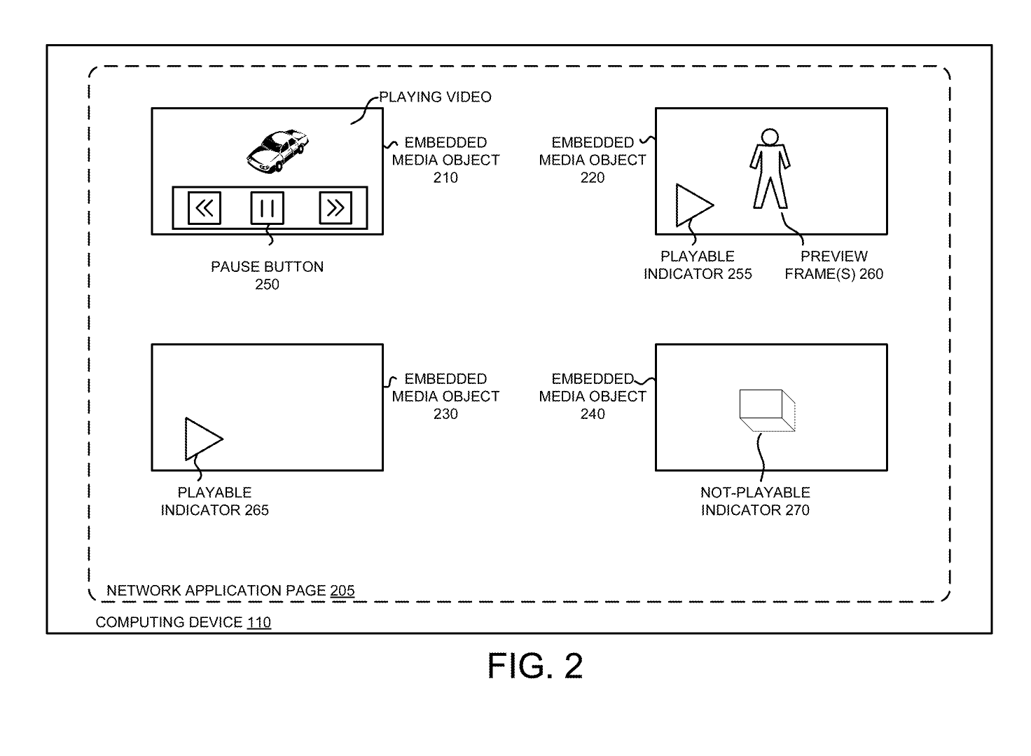

FIG. 2 illustrates a network application page displayed on a computing device with multiple embedded media objects according to one embodiment. As illustrated in FIG. 2, the embedded media objects 210, 220, 230, and 240 are currently viewable on the viewing area of the network application page 205. It should be understood that viewable and playable do not mean the same thing. Viewable is used to refer that the embedded media object itself can currently be viewed; whereas a playable embedded media object is used to refer to the content of that embedded media object (e.g., the media file) being able to be played on the computing device. The network application page 205 may be displayed as a result of a user of the computing device 110 navigating the network application 115 to a particular address.

As illustrated in FIG. 2, the embedded media objects 210, 220, 230, and 240 are in different states. The embedded media object 210 is currently playing media inline. For example, a user has selected the embedded media object 210 and the content of the embedded media object 210 is streaming or has been downloaded to the computing device 110 and is currently playing.

A playable validation procedure has been performed on the embedded media object 220, which has been validated as playable. As a result, the playable indicator 255 is displayed. The playable indicator 255 may be located within the area defined for the embedded media object 220 or located in an area substantially close to the area defined for the embedded media object 220. A preview frame loading procedure has also been performed on the embedded media object 220. As a result, one or more preview frames 260 are displayed for the embedded media object 220 to provide the user of the computing device 110 a visual preview of the content of the embedded media object 220. In some embodiments, if there are multiple preview frames, they are periodically cycled which may create the appearance of a preview animation.

Similarly to the embedded media object 220, the playable validation procedure has been performed on the embedded media object 230, which has been validated as playable. As a result, the playable indicator 265 is displayed. A preview frame loading procedure has not yet been performed on the embedded media object 220.

The playable validation procedure has also been performed on the embedded media object 240. However, unlike the embedded media objects 220 and 230, the embedded media object 240 has been determined as not playable on the computing device 110. For example, the content of the embedded media object 240 may be of a file format that cannot be played on the computing device 110 (e.g., the computing device 110 does not have the appropriate codec installed to playback the media item). As a result, the not-playable indicator 270 is displayed. The not-playable indicator 270 may be located within the area defined for the embedded media object 240 or located in an area substantially close to the area defined for the embedded media object 240.

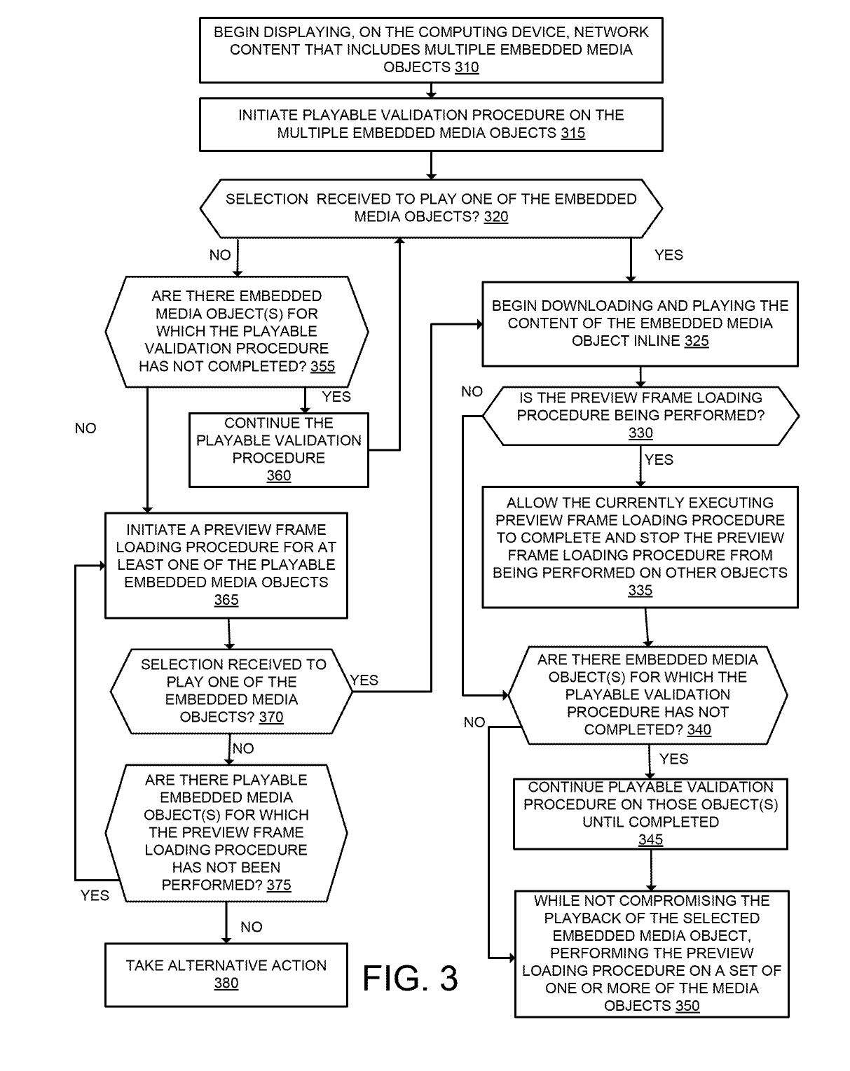

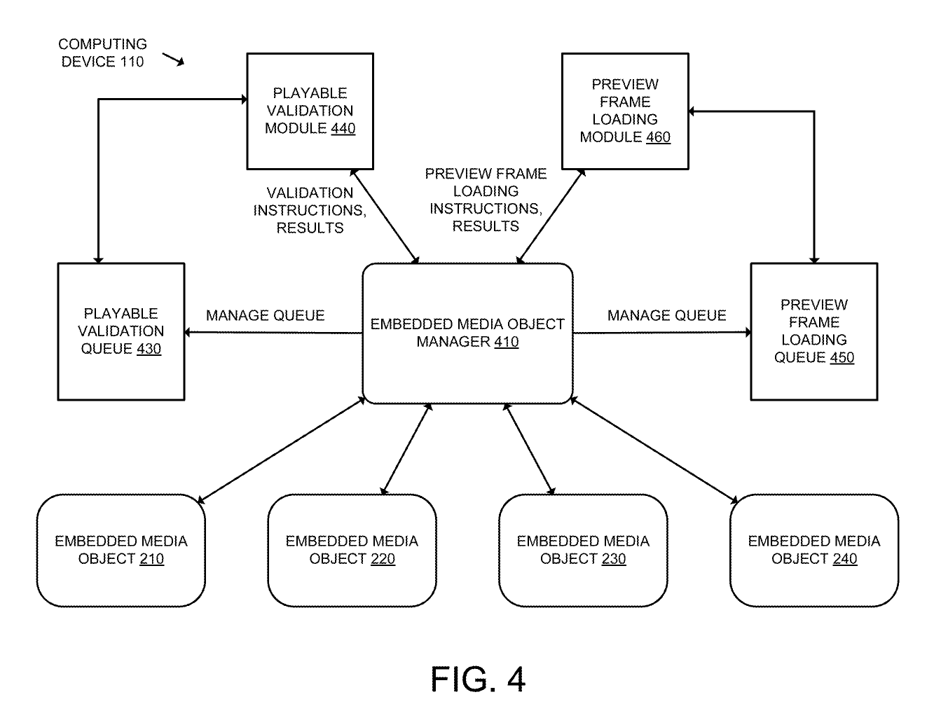

FIG. 3 is a flow chart illustrating exemplary operations for selective media download and playback according to one embodiment. The operations of FIG. 3 will be described with reference to the exemplary embodiment of FIG. 4. FIG. 4 is a block diagram illustrating exemplary selective media download and playback processing components according to one embodiment. It should be understood that the operations of FIG. 3 can be performed by embodiments of the invention other than those discussed with reference to FIG. 4, and the embodiments discussed with reference to FIG. 4 can perform operations different than those discussed with reference to FIG. 3.

FIG. 4 includes the embedded media object manager 410 coupled with the embedded media objects 210, 220, 230, and 240. The embedded media object manager 410 is also coupled with the playable validation queue 430, the playable validation module 440, the preview frame loading queue 450, and the preview frame loading module 460. The embedded media object manager 410 manages the embedded media objects 210, 220, 230, and 240. For example, the embedded media object manager 410 receives status updates and requests from the embedded media objects 210, 220, 230, and 240 and responds appropriately. For example, an embedded media object may send a message to the embedded media object manager 410 when it is currently viewable on the screen, when it has received a selection for playback, when it has received a request to pause playback, etc. The embedded media object manager 410 also manages the playable validation queue 430 and the preview frame loading queue 450, which will be described in greater detail later herein. As will be described in greater detail later herein, the embedded media object manager 410 manages the preview frame loading procedure such that playback of an embedded media file is not substantially affected. It should be understood that the architecture of FIG. 4 is exemplary, and different embodiments may include more modules, less modules, combined modules, etc. For example, in some embodiments the embedded media object manager includes the playable validation module 440 and/or the preview frame loading module 460.

Referring to FIG. 3, at block 310, network content that includes multiple embedded media objects is displayed on a network application page of the computing device. The embedded media objects have a source remote to the computing device. For example, with reference to FIG. 2, the embedded media objects 210, 220, 230, and 240 are displayed on the network application page 205.

Flow then moves to block 315, where a playable validation procedure is initiated for each of the embedded media objects. With reference to FIG. 4, the embedded media objects manager 410 detects or receives an indication that the media objects 210, 220, 230, and 240 are embedded on the network application page that is currently being processed on the computing device 110. For each of those embedded media objects, the embedded media object manager 410 creates and places a corresponding task on the playable validation queue 430. The playback validation module 440 then begins performing the playable validation tasks on the playable validation queue 430. In addition, in some embodiments the embedded media object manager 410 creates and places a preview frame loading procedure task for each of the embedded media objects 210, 220, 230, and 240 on the preview frame loading queue 450, which will be described in greater detail later herein.

It should be understood that some of the embedded media objects 210, 220, 230, and 240 may be validated prior to other ones of the embedded media objects. For purposes of explanation, the embedded media object 210 is the first object to complete the playable validation procedure.

For each embedded media object, the playable validation procedure will be complete when it is determined whether that object is playable on the computing device 110. A playable indicator is displayed for those embedded media objects which have been verified as playable, and in some embodiments, a not-playable indicator is displayed for those embedded media objects which have been determined to not be playable on the computing device 110. In some embodiments, the not-playable indicator includes information regarding how to make the corresponding embedded media object playable (e.g., a link to install a missing codec, etc.).

Flow moves from block 315 to block 320, where it is determined whether a user has selected one of the embedded media objects for playback. If the computing device has received a selection from a user of one of the embedded media objects for playback, then flow moves to block 325; otherwise flow moves to block 355. For example, with reference to FIG. 4, the embedded media object 210 has been validated as playable and the user of the computing device 110 has selected it for playback. The embedded media object manager 410 receives a message from the embedded media object 210 that it has been selected for playback. At block 325, the content of the embedded media object 210 begins downloading and begins playing inline on the network application page 205. In one embodiment, the downloading is according to methods described in greater detail in U.S. patent application Ser. No. 12/163,118, filed Jun. 27, 2008, entitled “Improved Methods and Systems for Rapid Data Acquisition Over the Internet,” and in U.S. patent application Ser. No. 12/145,784, filed Jun. 25, 2008, entitled “Systems and Methods for Managing Data Storage,” both of which are incorporated by reference herein in their entireties. Flow moves from block 325 to block 330.

At block 355 (the computing device has not received a selection to play one of the embedded media objects), where a determination is made whether there are other embedded media object(s) for which the playable validation procedure has not yet completed. If there are, then flow moves to block 360 where the playable validation procedure is continued; otherwise flow moves to block 365.

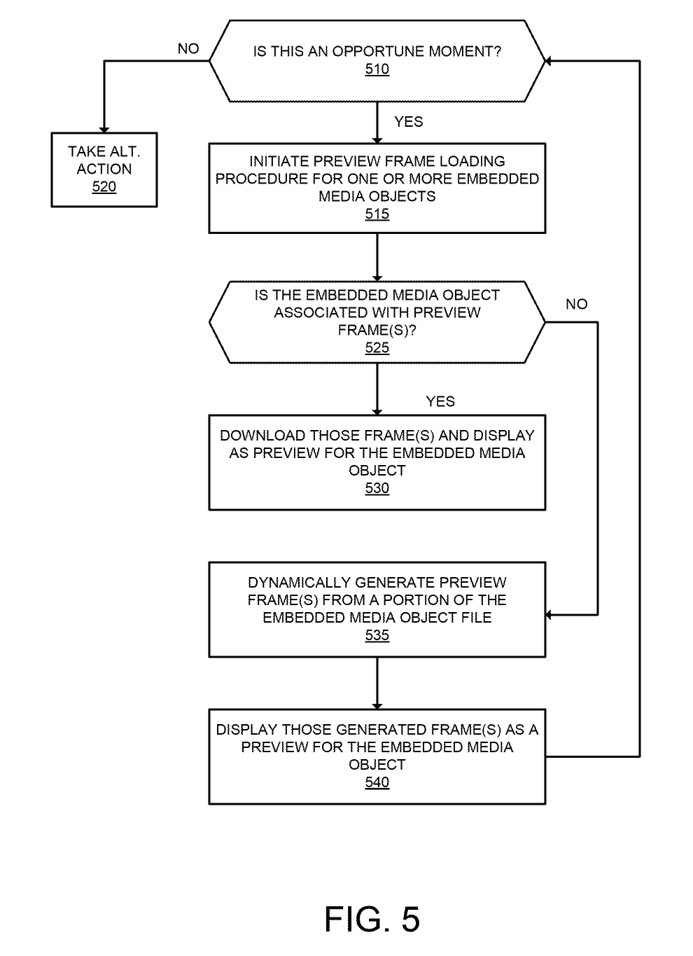

At block 365, a preview frame loading procedure is initiated for at least one of the playable embedded media objects on the network application page 205. It should be understood that the preview frame loading procedure for an embedded media object includes downloading at least one frame (and possibly more frames) of the corresponding media file. In one embodiment the preview frame loading procedure is not performed on embedded media objects that are embedded audio files. In other embodiments, for audio media items, the preview frame loading procedure may include downloading album artwork or other images associated with that audio media item. The preview frame loading procedure will be described in greater detail with respect to FIGS. 5-7.

With reference to FIG. 2, the preview frame loading procedure will not be performed on the embedded media object 210 since it is currently playing. The preview frame loading procedure will also not be performed on the embedded media object 240 since it is not playable on the computing device 110. With reference to FIG. 4, the embedded media object manager 410 creates and places a corresponding preview frame loading task for one or more of the embedded media objects 220 and 230 on the preview frame loading queue 450. Sometime later, the embedded media object manager 410 instructs the preview frame loading module 460 to perform the tasks on the preview frame loading queue 450.

Flow moves from block 365 to block 370, where it is again determined whether the computing device as received a selection to play one of the embedded media objects. If the computing device does receive a selection, then flow moves to back to block 325, otherwise flow moves to block 375. At block 375, the computing device determines if there are any other playable embedded media objects for which the preview frame loading procedure has not been performed. If there is, then flow moves back to block 365, otherwise flow moves to block 380 where alternative action is taken (e.g., the process ends until a selection of an embedded media item for playback).

An embedded media object may be selected for playback prior to the playable validation procedure and/or the preview frame loading procedure completing for the other embedded media objects on the network application page. In one embodiment, the playable validation procedure is allowed to complete for those other embedded media objects (that is, the playable validation procedure is not substantially interrupted when one of the embedded media objects plays media in inline mode), whereas the preview frame loading procedure is allowed to complete the procedure for only those preview frame loading tasks that are currently executing. As will be described in greater detail later herein, the preview frame loading procedure may be performed for the other embedded media objects during a period when its performance would not substantially affect the playback of a currently playing embedded media item (an opportune moment).

With reference to FIG. 3, flow moves from block 325 to block 330 where a determination is made whether the preview frame loading procedure is currently being performed for one or more embedded media objects. If it is, then flow moves to block 335 where the preview frame loading tasks currently being performed are allowed to continue and the preview frame loading procedure for the other embedded media objects on the network application page 205 is interrupted. With reference to FIG. 4, the preview frame loading module 460 completes processing the task(s) it is currently processing but does not process any other tasks on the preview frame loading queue 450, until there is an opportune moment. Flow moves from blocks 330 and 335 to block 340.

At block 340, a determination is made whether there are other embedded media object(s) for which the playable validation procedure has not yet completed. If there are, then flow moves to block 345 where the playable validation procedure is completed for those embedded media object(s), otherwise flow moves to block 350. Flow also moves from block 345 to block 350.

At block 350, a preview frame loading procedure is performed on one or more of the embedded media objects of the network application page 205 without compromising the playback of the selected embedded media object 210. For example, the preview frame loading procedure is initiated, during an opportune moment, for one or more of those embedded media objects that have not had the procedure performed. FIG. 5 is a flow chart illustrating exemplary operations for a preview frame loading procedure according to one embodiment. The operations of FIG. 5 will be described with reference to the exemplary embodiment of FIG. 4. However, it should be understood that the operations of FIG. 5 can be performed by embodiments other than those discussed with reference to FIG. 4, and the embodiments discussed with reference to FIG. 4 can perform operations different than those discussed with reference to FIG. 5.

In one embodiment, the preview frame loading module 460 performs the preview frame loading procedure only during an opportune moment (a period when performing the preview frame loading procedure will not substantially affect the playback of a media item playing in an embedded media object). With reference to FIG. 5, at block 510 the embedded media object manager 410 determines whether an opportune moment exists. By way of example, opportune moments include the following: when no embedded media objects have been selected for playback, when the playback buffer is full or reaches a buffer threshold, when playback has completed or downloading has completed, responsive to a user-initiated pause or stop of the playing media item, switching between applications (e.g., the user has switched from viewing the network application page 205 to viewing/using a different application), etc.

The embedded media object manager 410 determines opportune moments based on messages from the embedded media objects. For example, a user-initiated pause may occur when a pause button control is selected on an embedded media object. For example, with reference to FIG. 2, the embedded media object 210 includes the pause button 250, which when selected by a user, causes a message to be generated and sent to the embedded media object manager 410. In some cases, an opportune moment may not exist as a result of a user-initiated pause. For example, a user may pause the playback in order to allow the playback buffer to fill. Thus in some embodiments, the embedded media object manager 410 checks whether the playback buffer is full over a user-initiated pause buffer threshold. If over the threshold, an opportune moment exists, otherwise an opportune moment does not exist.

If the embedded media object manager 410 determines an opportune moment exists, then flow moves to block 515, otherwise the flow moves to block 520 where alternative action is taken (e.g., flow remains at block 510, or the embedded media object manager 410 instructs the preview frame loading module 460 to cease processing any new tasks from the preview frame loading queue 450 (the task(s) currently being processed may be completed)).

In some embodiments, an opportune moment ceases to exist responsive to a user selecting an embedded media object to play in full-screen mode, as this is a likely indication that the user wants to view that playing media item more than viewing previews from the other embedded media objects on the network application page. Thus the bandwidth and processing resources necessary for the preview frame loading procedure are available for the playing media file. When the full-screen playback is exited, the preview frame loading procedure process may resume (e.g., determining whether there is an opportune moment, etc.). Of course it should be understood that an opportune moment may cease in other circumstances (e.g., the playback buffer drops below a certain threshold, etc.).

At block 515 (there is an opportune moment), the embedded media object manager 410 initiates the preview frame loading procedure for one or more of the embedded media objects (one or more of the corresponding tasks on the preview frame loading queue 450). For example, the embedded media object manager 410 instructs the preview frame loading module 460 to begin processing one or more tasks on the preview frame loading queue 450. It should be understood that once an opportune moment ceases, the embedded media object manager 410 instructs the preview frame loading module 460 to not process any new tasks from the preview frame loading queue 450 (the task(s) currently being processed may be completed).

In some embodiments, the embedded media object manager 410 prioritizes embedded media objects for the preview loading frame procedure and/or the playable validation procedure based on their current position on the viewable area of the network application page. For example, embedded media objects which are not currently viewable (e.g., currently obstructed by other windows or applications, not viewable until the page is scrolled, etc.) will have a lower priority than embedded media objects currently viewable. Priority of the embedded media objects may affect the position in the preview frame loading queue 450 and/or the playable validation queue 430 in one embodiment.

Flow moves from block 515 to block 525. The operations described in blocks 525 to 540 are performed for each preview frame loading task being processed. It should be understood that these tasks may be processed concurrently or sequentially. At block 525, for the preview frame loading task being processed, the preview frame loading module 460 determines whether the corresponding embedded media object is associated with one or more preview frames. For example, some embedded media objects are defined with a set of one or more preview frames (e.g., a poster frame). If the corresponding embedded media object is associated with one or more preview frames, then flow moves to block 530 where those frames are downloaded from the corresponding embedded media object content provider and displayed as preview frame(s) for the embedded media file.

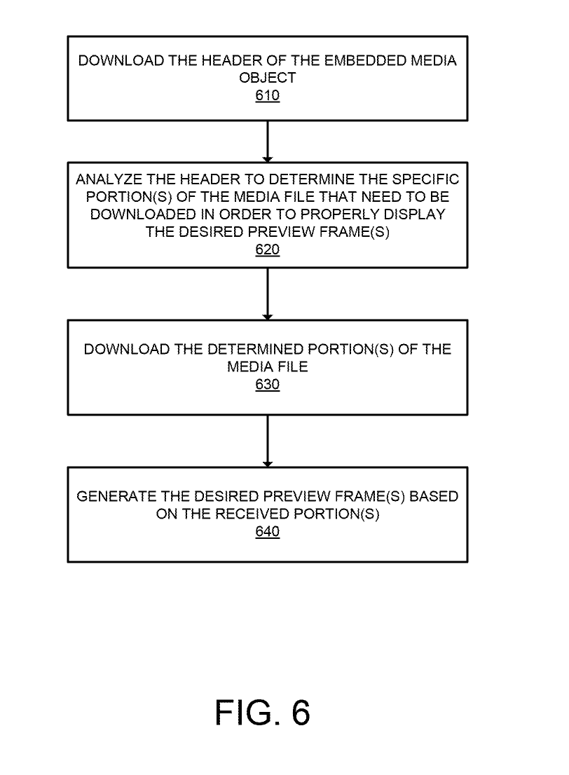

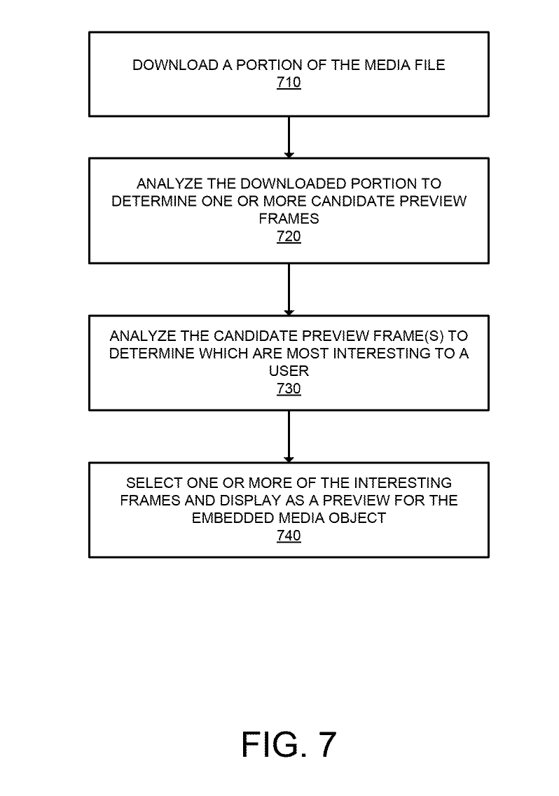

If the corresponding embedded media object is not associated with a preview frame, then flow moves to block 535 where the preview frame loading module 460 dynamically generates one or more preview frames from a portion of the file corresponding to the embedded media object. Exemplary operations for dynamically generating preview frames will be described in FIGS. 6 and 7. Flow moves from block 535 to block 540, where those generated frame(s) are displayed as a preview for the embedded media object. Flow moves from block 540 back to block 510.

FIG. 6 is a flow chart illustrating exemplary operations for dynamically generating one or more preview frames for an embedded media object according to one embodiment. In the operations of FIG. 6, a set of one or more frames of an embedded media object is desired to act as preview frame(s). The number of frames is typically predefined, as well as the general location of those frames (e.g., the 5^{th} frame of the embedded media file, the frame at the one minute mark of the embedded media file, the frame at ten percent completion of the embedded media file, etc.). In one embodiment, the preview frame loading module 460 performs the operations described in reference to FIG. 6.

At block 610, the header of the embedded media file is downloaded. In some embodiments the header of the embedded media file may have previously been downloaded (e.g., when determining whether the embedded media object is playable) and need not be downloaded again. Flow moves from block 610 to block 620.

At block 620, the header is analyzed to determine the specific portion(s) of the media file that need to be downloaded such that the desired preview frame(s) may be displayed. It should be understood that multiple frames may need to be downloaded in order to properly construct the desired frames (even if there is only a single desired frame). Flow moves from block 620 to block 630, where the determined portion(s) of the media file are downloaded from the embedded media object source content provider. Flow moves from block 630 to block 640 where the desired preview frame(s) are generated based on the received portion(s) of the media file.

FIG. 7 is a flow chart illustrating exemplary operations for an alternative embodiment for dynamically generating one or more preview frames for an embedded media object. In one embodiment, the preview frame loading module 460 performs the operations described in reference to FIG. 7.

At block 710, a portion of the media file is downloaded from its embedded media object content provider. For example, a certain number of seconds of the embedded media file may downloaded. Flow moves from block 710 to block 720, where the downloaded portion is analyzed to determine a set of one or more candidate preview frames. Flow then moves to block 730, where the set of candidate preview frames are analyzed to determine which frame(s) may be interesting to the user. For example, an uninteresting frame may be a frame that is blank, has the same color, etc. Flow then moves to block 740 where one or more of the interesting candidate frames are selected and displayed as a preview for the embedded media object.

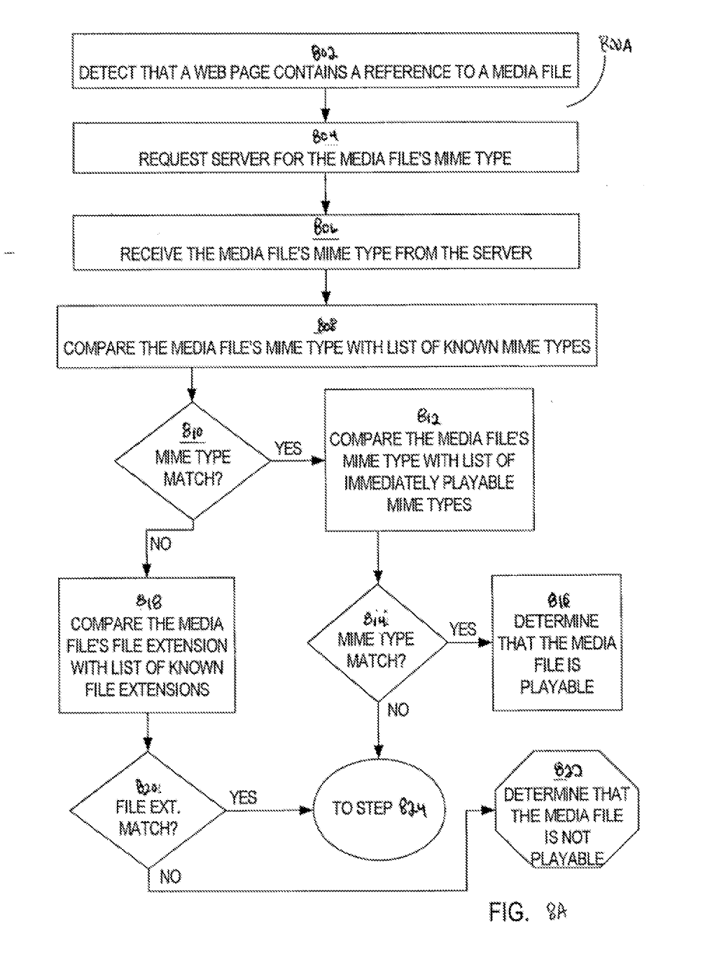

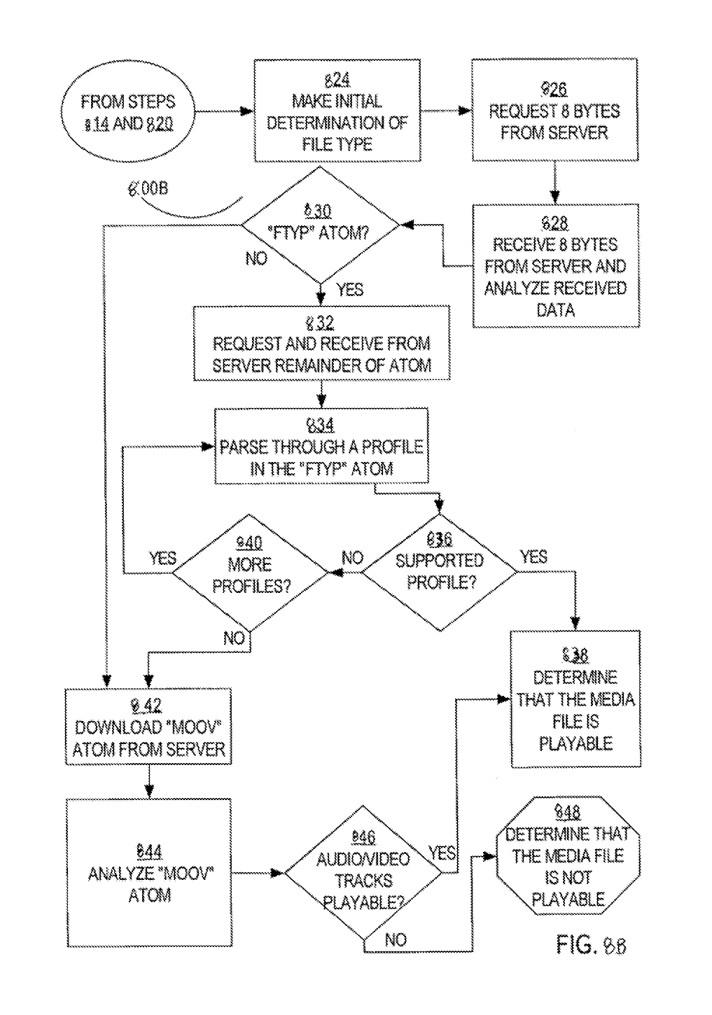

FIGS. 8A-8B are flow charts illustrating exemplary operations for determining whether an embedded media object is playable on a computing device according to one embodiment. In one embodiment, the playback validation module 440 performs the operations described in FIGS. 8A-8B.

The flow diagram in FIG. 8A illustrates a process 800A in which information from a server external to the media file is used to make a determination of playability. If, based on this information, it cannot be determined definitely whether an embedded media object is playable, the operations illustrated in FIG. 1B may be performed in which a portion of the media file itself is analyzed to determine whether the media file is playable.

In block 802, a network application (e.g., a web browser) detects that a network application page (e.g., a web page), contains an embedded reference to a media file. This may be done by examining the file extension of the file specified in an HREF attribute or EMBED element, or by examining the TYPE attribute of and EMBED or OBJECT element.

Upon detection of an embedded media file, the network application in block 804 sends a request to the embedded media object content provider for the media file's MIME type. A MIME type is a two-part identifier for file formats. Examples of MIME types include “audio/mp3” (indicates that the file is an audio file in an MPEG-1 Audio Layer 3) and “video/mp4” (indicates that the file is a video file in the MPEG4 format). In block 806, the embedded media object content provider returns the media file's MIME type to the network application.

Next, in block 808, the network application compares the media file's MIME type with a list of known MIME types. The list of known MIME types is specific to each computing device on which the network application operates because whether a media file is playable by a computing device depends on what applications have been installed on the specific computing device. In block 810, the network application determines if there is a match between the media file's MIME type and a MIME type listed in the list of known MIME types. If there is a match, then the media file may be playable by the computing device. Further steps are performed to determine if the media file is indeed playable by the device.

In block 812, the media file's MIME type is compared with a second list of MIME types which is a subset of the list of known MIME types. The second list consists of “immediately playable” MIME types. In block 814, if the network application determines that that there is a match between the media file's MIME type and a MIME type in the list of “immediately playable” MIME types, then block 816 is reached and the network application determines that the media file is playable by the device. In other words, the list of “immediately playable” MIME types contains all MIME types which are known to be definitely playable by the device. For example, in one embodiment, the MIME type “audio/mp3”, which denotes an audio file in the MPEG3 format, is known to be playable by a computing device. Therefore, if a media file's MIME type is “audio/mp3”, then the network application determines that this media file is playable without further investigation.

On the other hand, if there is no match between the media file's MIME type and the list of “immediately playable” MIME types in block 814, then the network application may need to perform further steps to determine whether the media file is playable on the computing device. These further steps commence with block 824 and are described in detail below with respect to FIG. 8B.

Going back to block 810, if there is no match between the media file's MIME type and the list of known MIME types, block 818 is performed. In block 818, the network application compares the media file's file extension with a list of known file extensions. The file extension may be obtained from the path to the media file. Similar to the list of known MIME types, the list of known file extensions is specific to each computing device. The list of known file extensions contains all file extensions which may be played by a computing device. In block 820, if there is no match between the media file's file extension and a file extension in the list of known file extensions, then block 822 is reached and the network application determines that this media file is not playable. On the other hand, if there is a match between the media file's extension and a file extension in the list of known file extensions, then the network application may need to perform further steps to determine whether the media file is playable on the computing device. These further steps commence with block 824 and are described in detail below with respect to FIG. 8B.

As discussed above, if the network application cannot determine whether a media file is playable by a computing device based on a media file's MIME type and file extension alone, then the network application may request additional data from the server (embedded media object content provider) to perform further analysis. The flow diagram in FIG. 8B illustrates a process 800B in which portions of a media file are obtained from a server and are used to make a determination of playability.

In block 824, the network application makes an initial determination, based on the media file's MIME type and file extension, regarding what kind of format is in the media file. For example, if the media file has a file extension of “.MP4”, then the network application determines that the media file is likely in a format in the MPEG4 family of formats. In another example, if the media file has an extension of “.MOV”, then the web browser determines that the media file is likely in a format in the QuickTime family of formats. Based on this initial determination, the network application requests the first eight bytes of the media file from the server in block 826.

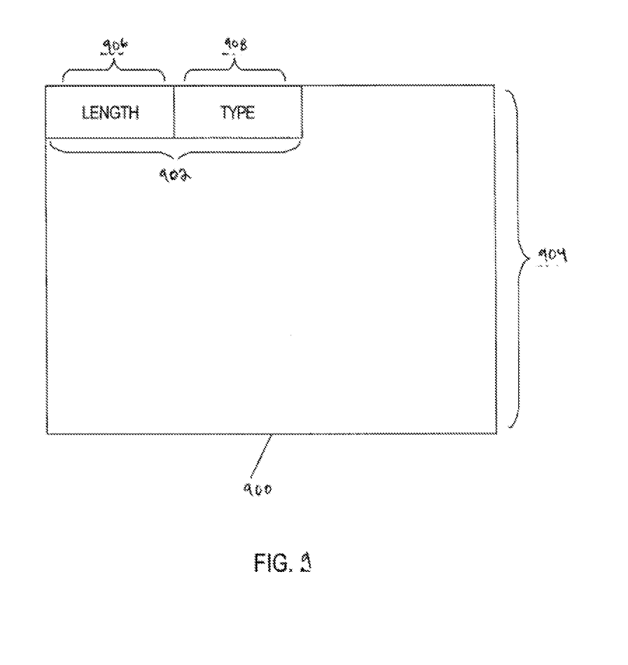

When a media file is in the MPEG4 or QuickTime family of formats, the first eight bytes of the media file is the “header” of the first “atom” of the media file. FIG. 9 depicts an example of an “atom” in a media file. Atom 900 consists of a header 902 and content 904. The header is eight bytes long and consists of a length cell 906 and a type cell 908. Both the length cell 906 and the type cell 908 are four bytes long each. Length cell 906 contains length data, which indicates the length of content 904. Type cell 908 indicates what type of atom is atom 900. A media file in the MPEG4 or QuickTime family consists of a plurality of atoms, which all contain a header in its first eight bytes that indicates the length and type of atom.

One type of atom is the “moov” (movie) atom. The contents of a “moov” atom contains information about how the movie is encoded and a table of contents for the media file. Another type of atom is an “mdat” (movie data) atom. An “mdat” atom contains the video and/or audio data in the media file. A third type of atom is an “ftyp” (file type) atom. The “ftyp” atom identifies the format of the media file within the MPEG4 or QuickTime family. Significantly, atoms in a MPEG4 or QuickTime media file can be arranged in any order. That is, although a “moov” atom contains the table of contents for the media file, it may actually follow the “mdat” atom(s) of the media file. One exception is the “ftyp” atom. If a media file contains an “ftyp” atom, the “ftyp” atom is always the first atom located in the media file.

In block 828, the network application receives the first eight bytes of the media file. As discussed above, these eight bytes constitute the header of the first atom of the media file. The network application analyzes the header, specifically the type cell of the header, and determines whether the header is the header of an “ftyp” atom. In block 130, if the header does not indicate an “ftyp” atom, then the network application downloads a “moov” atom from the server in block 842 in order to gather additional data about the media file. Block 842 is discussed in more detail below. If the header indicates an “ftyp” atom, then in block 832, the web browser requests the server for the entirety of the “ftyp” atom in order to perform analysis on the contents of the “ftyp” atom.

The content of a media file's “ftyp” item contains a series of “profiles” from which the network application can derive information about the format of the media file. Specifically, each profile contains information about what codec (coding and decoding) formats and bit rates are compatible with the audio and video data in the media file. An “ftyp” atom may contain more than one profile because the audio and video data in a media may be compatible with multiple coding formats and bit rates.

In block 834, the network application parses through profiles in an “ftyp” atom one at a time to extract format information. In block 836, the network application compares the extracted format information to information about what formats are supported, or playable, by a computing device. Information about what formats are supported by a computing device may be derived from what types of applications are installed on that device. Once again, this information is specific to each computing device. If the network application determines that the profile is supported in that it indicates that a format compatible with the media file is supported, or playable, by the computing device, then the network application determines in block 138 that the media file is playable by the computing device. In block 836, if the web browser determines that the profile is not supported, then further examination of the “ftyp” atom is performed.

In block 840, if the network application detects that there are more profiles in the “ftyp” atom which have not been analyzed, block 834 is repeated. In block 834, the next profile is parsed and the format information contained in the profile is extracted. However, if the end of the “ftyp” atom has been reached and there are no more profiles to parse, then additional information is gathered by requesting and receiving data until the “moov” atom is received in block 842.

As FIG. 8B illustrates, the network application requests and receives data until a “moov” atom has been received from the server in block 842 either when it has detected that the media file does not contain an “ftyp” atom (block 830) or when it has reached the end of an “ftyp” atom without detecting a supported profile (block 840). The request and receipt of atoms in block 842 is accomplished with minimal downloading of data from the server by taking advantage of the atom structure in the media file. As discussed above and illustrated in FIG. 9, each atom contains a header, and a header contains information about the length of the atom and the type of the atom. Therefore, the network application may request the server for just eight bytes of header to determine whether an atom is a “moov” atom. Furthermore, the network application need not download the entirety of an atom before it can request the header of the following atom. The network application can calculate an offset value based on the length information contained in the header of an atom and send the offset value to the server to obtain the header of the following atom. In other words, the atom structure allows the network application to request data from the server eight bytes at a time, skipping over lengthy contents while obtaining only the headers.

In block 844, the network application receives the “moov” atom from the server and analyzes the “moov” atom for information about the media file's format. Sometimes, a “moov” atom may also be large and may contain several megabytes of data. Therefore, downloading an entire “moov” atom may also incur unwanted time and cost. A “moov” atom's content, however, is itself divided into “sub-atoms”, where the header of each “subatom” indicates the length and type of “sub-atom”. Consequently, in block 844, the network application downloads only the headers of the “moov” atom's sub-atoms, skipping over irrelevant content until it detects a sub-atom which contains information about the media file's format. For example, the “moov” atom may contain sub-atoms which contain information about the media file's audio track and the media file's video track.

The network application may extract information from the audio track and video track sub-atoms, and compares them to formats that are supported, or playable, by a device. For example, the video track sub-atom may indicate that the media file's video data has been compressed using “B-frames” (bi-directional frames), while the device does not have any applications which can play video data compressed into “B-frames”. In this example, in block 846, the network application determines that the video track is not supported by the device, and determines in block 848 that the media file is not playable by the device. In another example, the video track sub-atom may indicate that the media file's video data has been compressed using “I-frames” (intra frames), and the device does contain at least one application that can play video data compressed into “I-frames”. In this example, if the audio track is similarly supported, in the block 846, the network application determines that the audio and video tracks are playable and determines in block 838 that the media file is playable by the device.

Although an embodiment of the invention is described above in processes 800A and 800B (and FIGS. 8A and 8B) with respect to a specific flow diagram tailored to media files whose MIME types are maintained by a server and which belong in the MPEG4 or QuickTime family of formats, in alternative embodiments of the invention, processes 800A and 800B may be modified to perform similar analyses for media files with different formats.

In addition to the details described in reference to FIGS. 8A-9, more detail regarding determining whether an embedded media object is playable on a computing device may be found in U.S. patent application Ser. No. 12/143,119, filed Jun. 20, 2008, entitled “Determining Playability of Media Files With Minimal Downloading,” which is incorporated by reference herein in its entirety.

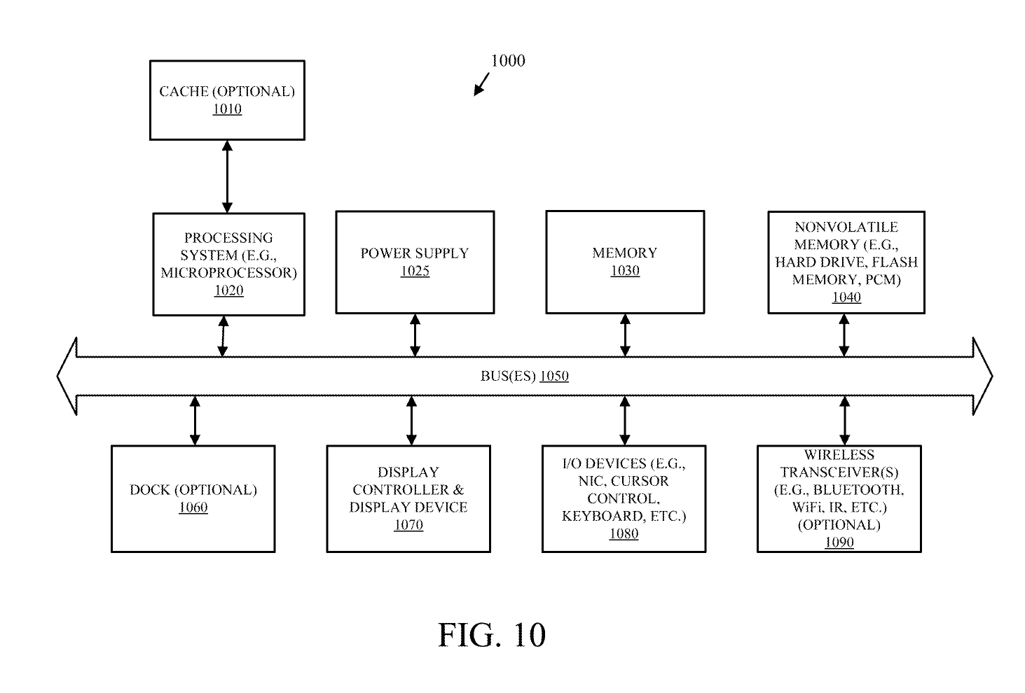

FIG. 10 is a block diagram illustrating an exemplary computer system which may be used in some embodiments of the invention. For example, the exemplary architecture of the computer system 1000 may be included in the computing device 110. It should be understood that while FIG. 10 illustrates various components of a computer system, it is not intended to represent any particular architecture or manner of interconnecting the components as such details are not germane to the present invention. It will be appreciated that other computer systems that have fewer components or more components may also be used with the present invention.

As illustrated in FIG. 10, the computer system 1000, which is a form of a data processing system, includes the bus(es) 1050 which is coupled with the processing system 1020, power supply 1025, memory 1030, and the nonvolatile memory 1040 (e.g., a hard drive, flash memory, Phase-Change Memory (PCM), etc.). The bus(es) 1050 may be connected to each other through various bridges, controllers, and/or adapters as is well known in the art. The processing system 1020 may retrieve instruction(s) from the memory 1030 and/or the nonvolatile memory 1040, and execute the instructions to perform operations as described above. The bus 1050 interconnects the above components together and also interconnects those components to the optional dock 1060, the display controller & display device 1070, Input/Output devices 1080 (e.g., NIC (Network Interface Card), a cursor control (e.g., mouse, touchscreen, touchpad, etc.), a keyboard, etc.), and the optional wireless transceiver(s) 1090 (e.g., Bluetooth, WiFi, Infrared, etc.).

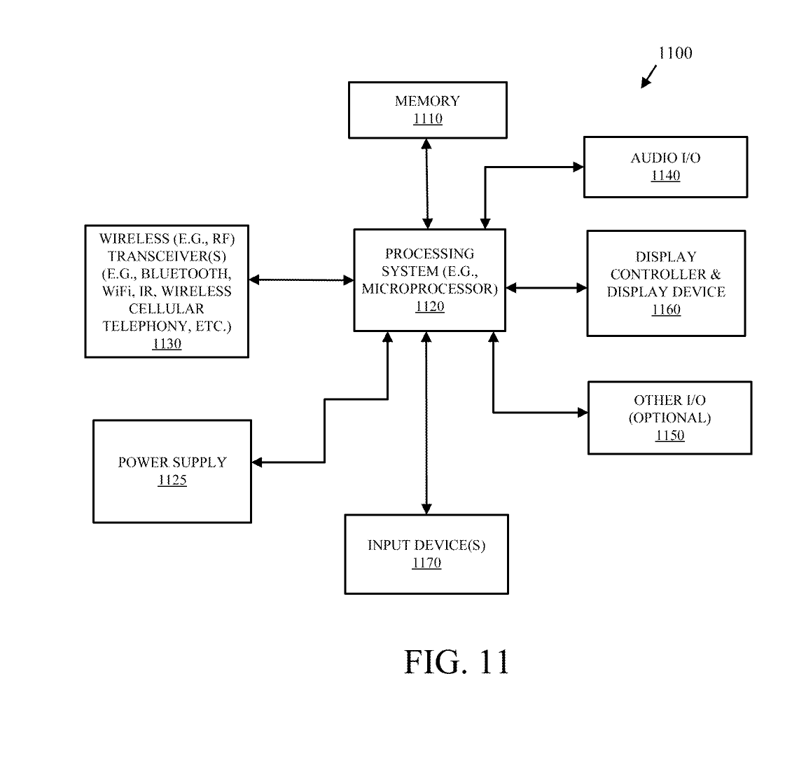

FIG. 11 is a block diagram illustrating an exemplary data processing system which may be used in some embodiments of the invention. For example, the data processing system 1100 may be a handheld computer, a personal digital assistant (PDA), a mobile telephone, a portable gaming system, a portable media player, a tablet or a handheld computing device which may include a mobile telephone, a media player, and/or a gaming system. As another example, the data processing system 1100 may be a network computer or an embedded processing device within another device.

According to one embodiment of the invention, the exemplary architecture of the data processing system 1100 may be included in the computing device 110. The data processing system 1100 includes the processing system 1120, which may include one or more microprocessors and/or a system on an integrated circuit. The processing system 1120 is coupled with a memory 1110, a power supply 1125 (which includes one or more batteries) an audio input/output 1140, a display controller and display device 1160, optional input/output 1150, input device(s) 1170, and wireless transceiver(s) 1130. It will be appreciated that additional components, not shown in FIG. 11, may also be a part of the data processing system 1100 in certain embodiments of the invention, and in certain embodiments of the invention fewer components than shown in FIG. 11 may be used. In addition, it will be appreciated that one or more buses, not shown in FIG. 11, may be used to interconnect the various components as is well known in the art.

The memory 1110 may store data and/or programs for execution by the data processing system 1100. The audio input/output 1140 may include a microphone and/or a speaker to, for example, play music and/or provide telephony functionality through the speaker and microphone. The display controller and display device 1160 may include a graphical user interface (GUI). The wireless (e.g., RF) transceivers 1130 (e.g., a WiFi transceiver, an infrared transceiver, a Bluetooth transceiver, a wireless cellular telephony transceiver, etc.) may be used to communicate with other data processing systems. The one or more input devices 1170 allow a user to provide input to the system. These input devices may be a keypad, keyboard, touch panel, multi touch panel, etc. The optional other input/output 1150 may be a connector for a dock.

The techniques shown in the figures can be implemented using code and data stored and executed on one or more electronic devices (e.g., a computing device, a server, etc.). Such electronic devices store and communicate (internally and/or with other electronic devices over a network) code and data using machine-readable media, such as machine-readable storage media (e.g., magnetic disks; optical disks; random access memory; read only memory; flash memory devices; phase-change memory) and machine-readable communication media (e.g., electrical, optical, acoustical or other form of propagated signals—such as carrier waves, infrared signals, digital signals, etc.). In addition, such electronic devices typically include a set of one or more processors coupled to one or more other components, such as one or more storage devices, user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware.

While embodiments have described that the playable validation procedure is performed on each embedded media object before performing the poster frame loading procedure, other embodiments allow for the playable validation procedure for one or more embedded media objects to be performed concurrently with the poster frame loading procedure for one or more embedded media objects (which may be the same embedded media objects or different embedded media objects).

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method performed by a computing device for playing embedded media files, comprising:
initiating a playable validation procedure on a first set of two or more embedded media objects in a network application page, wherein the playable validation procedure determines to determine whether each of the first set of embedded media objects is playable on the computing device, wherein each of the first set of embedded media objects has a corresponding media file stored remotely from the computing device; and
responsive to receiving a selection to play a media file corresponding to one of the first set of embedded media objects, downloading and playing the selected media file inline through the corresponding embedded media object while continuing the playable validation procedure on those of the first set of embedded media objects that have not yet completed the playable validation procedure.

2. The method of claim 1, wherein the first set of embedded media objects are currently viewable on the network application page, wherein the network application page includes a second set of one or more embedded media objects that are not currently viewable on the network application page, and wherein the playable validation procedure is only performed on those embedded media objects that are currently viewable.

3. The method of claim 1, further comprising:
performing, while not compromising the playback of the selected media object, a preview frame loading procedure on one or more of the first set of embedded media objects to display one or more frames of a media file corresponding to that embedded media object as a preview.

4. The method of claim 3, wherein the preview frame loading procedure is performed on those of the first set of embedded media objects that have been successfully validated as playable and are currently viewable.

5. The method of claim 3, wherein the preview frame loading procedure is performed at one or more of: responsive to a playback buffer for the selected embedded media object reaching a buffer threshold, responsive to playback or downloading of the selected media file completing, responsive to a user-initiated pause or stop of the playback of the selected media file, and responsive to the selected embedded media object becoming not viewable.

6. The method of claim 3, wherein the preview frame loading procedure on an embedded media object includes performing the following:
determining whether the embedded media object is associated with one or more preview frames;
responsive to a determination that the embedded media object is associated with one or more preview frames, downloading those preview frames and displaying them as a preview; and
responsive to a determination that the embedded media object is not associated with one or more preview frames, dynamically generating a set of one or more preview frames from a portion of the media file corresponding to the embedded media object.

7. The method of claim 6, wherein dynamically generating the set of one or more preview frames includes performing the following:
downloading a header of the media file corresponding to the embedded media object;
analyzing the header to determine one or more portions of the media file to download to generate one or more preview frames;
downloading the one or more portions of the media file;
generating the one or more preview frames using the downloaded one or more portions of the media file; and
displaying the one or more preview frames as a preview.

8. A computing device, comprising:
a network application to display a network application page that includes a plurality of embedded media objects each having a source media file stored remotely from the computing device; and
an embedded media object manager to manage a playable validation procedure for the plurality of embedded media objects that determines whether they are playable on the computing device, wherein the playable validation procedure is to be performed on a set of one or more of the plurality of embedded media objects regardless of whether a set of one or more different ones of the plurality of embedded media objects is playing media inline on the network application page.

9. The computing device of claim 8, wherein the embedded media object manager is to create and place a playable validation task on a playable validation queue for each of the plurality of embedded media objects, wherein the embedded media object manager is to prioritize the playable validation procedure for those embedded media objects that are viewable through placement in the playable validation queue.

10. The computing device of claim 9, further comprising a playable validation module to perform the following:
perform the playable validation tasks on the playable validation queue,
cause a playable indicator to be displayed for each embedded media object successfully validated as playable on the computing device, and
cause a not-playable indicator to be displayed for each embedded media object that has been determined as not playable on the computing device.

11. The computing device of claim 8, wherein the embedded media object manager is further to manage a preview frame loading procedure for those of the plurality of embedded media objects which have been validated as playable on the computing device.

12. The computing device of claim 11, wherein the embedded media object manager is to create and place a preview frame loading task on a preview frame loading queue for those of the plurality of embedded media objects which have been validated as playable on the computing device, wherein the embedded media object is to prioritize the preview frame loading procedure for those embedded media objects that are viewable through placement in the preview frame loading queue.

13. The computing device of claim 12, further comprising a preview frame loading module to perform the following:
perform the preview frame loading tasks in order on the preview frame loading queue during periods of time when performance of the preview frame loading tasks would not substantially affect playback of a media file playing inline through one of the embedded media objects, and
wherein a result of each completed preview frame loading tasks is one or more preview frames to be used as a preview.

14. A machine-readable storage medium that provides instructions that, if executed by a processor of a computing device, will cause said processor to perform operations comprising:
initiating a playable validation procedure on a first set of two or more embedded media objects in a network application page, wherein the playable validation procedure determines to determine whether each of the first set of embedded media objects is playable on the computing device, wherein each of the first set of embedded media objects has a corresponding media file stored remotely from the computing device; and
responsive to receiving a selection to play a media file corresponding to one of the first set of embedded media objects, downloading and playing the selected media file inline through the corresponding embedded media object while continuing the playable validation procedure on those of the first set of embedded media objects that have not yet completed the playable validation procedure.

15. The machine-readable storage medium of claim 14, wherein the first set of embedded media objects are currently viewable on the network application page, wherein the network application page includes a second set of one or more embedded media objects that are not currently viewable on the network application page, and wherein the playable validation procedure is only performed on those embedded media objects that are currently viewable.

16. The machine-readable storage medium of claim 14, further comprising:
performing, while not compromising the playback of the selected media object, a preview frame loading procedure on one or more of the first set of embedded media objects to display one or more frames of a media file corresponding to that embedded media object as a preview.

17. The machine-readable storage medium of claim 16, wherein the preview frame loading procedure is performed on those of the first set of embedded media objects that have been successfully validated as playable and are currently viewable.

18. The machine-readable storage medium of claim 16, wherein the preview frame loading procedure is performed at one or more of: responsive to a playback buffer for the selected embedded media object reaching a buffer threshold, responsive to playback or downloading of the selected media file completing, responsive to a user-initiated pause or stop of the playback of the selected media file, and responsive to the selected embedded media object becoming not viewable.

19. The machine-readable storage medium of claim 16, wherein the preview frame loading procedure on an embedded media object includes performing the following:
determining whether the embedded media object is associated with one or more preview frames;
responsive to a determination that the embedded media object is associated with one or more preview frames, downloading those preview frames and displaying them as a preview; and
responsive to a determination that the embedded media object is not associated with one or more preview frames, dynamically generating a set of one or more preview frames from a portion of the media file corresponding to the embedded media object.

20. The machine-readable storage medium of claim 19, wherein dynamically generating the set of one or more preview frames includes performing the following:
downloading a header of the media file corresponding to the embedded media object;
analyzing the header to determine one or more portions of the media file to download to generate one or more preview frames;
downloading the one or more portions of the media file;
generating the one or more preview frames using the downloaded one or more portions of the media file; and
displaying the one or more preview frames as a preview.

21. A method performed by a computing device for playing embedded media files, comprising:
providing a network application page having a plurality of embedded media objects each having a corresponding media file stored remotely from the computing device; and
responsive to receiving a selection to play a media file corresponding to one of the embedded media objects, performing the following:
downloading and begin playing the selected media file inline, and
preventing initiation of a preview frame loading procedure for any of the remaining embedded media objects while at least the selected media file is being downloaded.

22. The method of claim 21, further comprising:
allowing a playable validation procedure to complete for each of the remaining embedded media objects while the selected media file is being downloaded.

23. The method of claim 21, further comprising:
initiating the preview frame loading procedure for at least one of the remaining embedded media objects to display one or more frames or images corresponding to the embedded media object as a preview while the selected media file is not being downloaded.

24. The method of claim 23, wherein the preview frame loading procedure on an embedded media object includes performing the following:
determining whether the embedded media object is associated with one or more preview frames;
responsive to a determination that the embedded media object is associated with one or more preview frames, downloading those preview frames and displaying them as a preview; and
responsive to a determination that the embedded media object is not associated with one or more preview frames, dynamically generating a set of one or more preview frames from a portion of the media file corresponding to the embedded media object.

25. The method of claim 24, wherein dynamically generating the set of one or more preview frames includes performing the following:
downloading a header of the media file corresponding to the embedded media object;
analyzing the header to determine one or more portions of the media file to download to generate one or more preview frames;
downloading the one or more portions of the media file;
generating the one or more preview frames using the downloaded one or more portions of the media file; and
displaying the one or more preview frames as a preview.

26. A machine-readable storage medium that provides instructions that, if executed by a processor of a computing device, will cause said processor to perform operations comprising:
providing a network application page having a plurality of embedded media objects each having a corresponding media file stored remotely from the computing device; and
responsive to receiving a selection to play a media file corresponding to one of the embedded media objects, performing the following:
downloading and begin playing the selected media file inline, and
preventing initiation of a preview frame loading procedure for any of the remaining embedded media objects while at least the selected media file is being downloaded.

27. The machine-readable storage medium of claim 26, further comprising:
allowing a playable validation procedure to complete for each of the remaining embedded media objects while the selected media file is being downloaded.

28. The machine-readable storage medium of claim 26, further comprising:
initiating the preview frame loading procedure for at least one of the remaining embedded media objects to display one or more frames or images corresponding to the embedded media object as a preview while the selected media file is not being downloaded.

29. The machine-readable storage medium of claim 28, wherein the preview frame loading procedure on an embedded media object includes performing the following:
determining whether the embedded media object is associated with one or more preview frames;
responsive to a determination that the embedded media object is associated with one or more preview frames, downloading those preview frames and displaying them as a preview; and
responsive to a determination that the embedded media object is not associated with one or more preview frames, dynamically generating a set of one or more preview frames from a portion of the media file corresponding to the embedded media object.

30. The machine-readable storage medium of claim 29, wherein dynamically generating the set of one or more preview frames includes performing the following:
downloading a header of the media file corresponding to the embedded media object;
analyzing the header to determine one or more portions of the media file to download to generate one or more preview frames;
downloading the one or more portions of the media file;
generating the one or more preview frames using the downloaded one or more portions of the media file; and
displaying the one or more preview frames as a preview.
